(19) United States
(12) Patent Application Publication
(10) Pub. No.: US 2014/0354558 A1
(43) Pub. Date: Dec. 4, 2014

(54) FLEXIBLE TOUCH SCREEN PANEL AND FLEXIBLE DISPLAY APPARATUS INCLUDING THE SAME

(71) Applicant: Samsung Display Co., Ltd., Yongin-City (KR)

(72) Inventors: Yong-Youl Cho, Yongin-City (KR); Chang-Bum Kim, Yongin-City (KR); Do-Ok Park, Yongin-City (KR)

(73) Assignee: Samsung Display Co., Ltd., Yongin-City (KR)

(21) Appl. No.: 14/067,924

(22) Filed: Oct. 30, 2013

(30) Foreign Application Priority Data
May 31, 2013 (KR) 10-2013-0063084

(51) Int. Cl. G06F 3/041

(52) U.S. Cl. CPC G06F 3/0412
USPC 345/173

(57) ABSTRACT

A flexible touch screen panel includes a flexible film, and a wiring layer in the flexible film, wherein the wiring layer is at a neutral plane within the flexible film, the neutral plane being a region where substantially no stress is applied when the flexible touch screen panel is bent.

### CROSS-REFERENCE TO RELATED APPLICATION

This application claims priority to and the benefit of Korean Patent Application No. 10-2013-0063084, filed on May 31, 2013, in the Korean Intellectual Property Office, the disclosure of which is incorporated herein in its entirety by reference.

### BACKGROUND

1. Field

Embodiments of the present invention relate to a flexible/bendable touch screen panel and a flexible display apparatus including the touch screen panel.

2. Description of the Related Art

Generally, a flexible display apparatus is prepared by forming a display unit on a flexible substrate, and has a very useful advantage in that it may be bent.

Furthermore, recently, most display apparatuses are configured to be operated by a user's touch, and to this end, a flexible display apparatus may use a flexible touch screen panel that may be flexibly bent.

However, the flexible touch screen panel includes a wiring layer formed of conductive materials, such as indium tin oxide, and cracks may be generated in the wiring layer when the flexible touch screen panel is bent. That is, when the flexible display apparatus is bent, the comparatively less flexible wiring layer of the touch screen panel can fail to endure the bending, thereby causing cracks to be generated.

The cracks may thus cause the wiring layer to be disconnected, thereby causing an electrical discontinuity, and an operational defect may occur. Accordingly, there is research into restricting the occurrence of such defects of such a product.

### SUMMARY

Embodiments of the present invention provide a flexible touch screen panel having an improved function of effectively reducing or preventing cracks in a wiring layer, and a flexible display apparatus including the touch screen panel.

According to an aspect of the present invention, there is provided a flexible touch screen panel including a flexible film, and a wiring layer in the flexible film, wherein the wiring layer is at a neutral plane within the flexible film, the neutral plane being a region where substantially no stress is applied when the flexible touch screen panel is bent.

A surface of the wiring layer may correspond to the neutral plane.

The flexible film may include a first film on which the wiring layer is located, and a second film above the wiring layer.

The first film and the second film may include polyethylene terephthalate (PET).

The flexible touch screen panel may further include a flexibility supplementation film at an upper surface of the wiring layer.

The flexibility supplementation film may include at least one of silver nanowires, metal mesh, graphene, or dry film resist.

The flexibility supplementation film and the wiring layer may include a same pattern.

The flexibility supplementation film may completely cover the upper surface of the wiring layer.

According to another aspect of the present invention, there is provided a flexible display apparatus including a flexible display panel, and a flexible touch screen panel coupled with the flexible display panel and configured to recognize a touch from a user and to send a signal corresponding to the touch, wherein the flexible touch screen panel includes a flexible film, and a wiring layer that corresponds to a neutral plane of the flexible film, the neutral plane being a region where substantially no stress is applied when the flexible touch screen panel is bent.

A surface of the wiring layer may correspond to the neutral plane.

The flexible film may include a first film on which the wiring layer is formed, and a second film above the wiring layer.

The first film and the second film may include polyethylene terephthalate (PET).

The flexible display apparatus may further include a flexibility supplementation film at an upper surface of the wiring layer.

The flexibility supplementation may include at least one of silver nanowires, metal mesh, graphene, or dry film resist.

The flexibility supplementation film may be patterned the same as the wiring layer.

The flexibility supplementation film may completely cover the upper surface of the wiring layer.

### BRIEF DESCRIPTION OF THE DRAWINGS

The above and other aspects of embodiments of the present invention will become more apparent by describing in detail exemplary embodiments thereof, with reference to the attached drawings in which:

FIG. 1 is a cross-sectional diagram illustrating a flexible display apparatus according to an embodiment of the present invention;

FIG. 2 is a cross-sectional diagram illustrating a structure of a flexible touch screen panel used in the flexible display apparatus of the embodiment shown in FIG. 1 according to an embodiment of the present invention;

FIG. 3 is a cross-sectional diagram illustrating a bent state of the flexible touch screen panel shown in FIG. 2; and

FIGS. 4 and 5 are cross-sectional diagrams illustrating modified examples of the flexible touch screen panel of the embodiment shown in FIG. 2.

### DETAILED DESCRIPTION

Expressions such as “at least one of,” when preceding a list of elements, modify the entire list of elements, and do not modify the individual elements of the list.

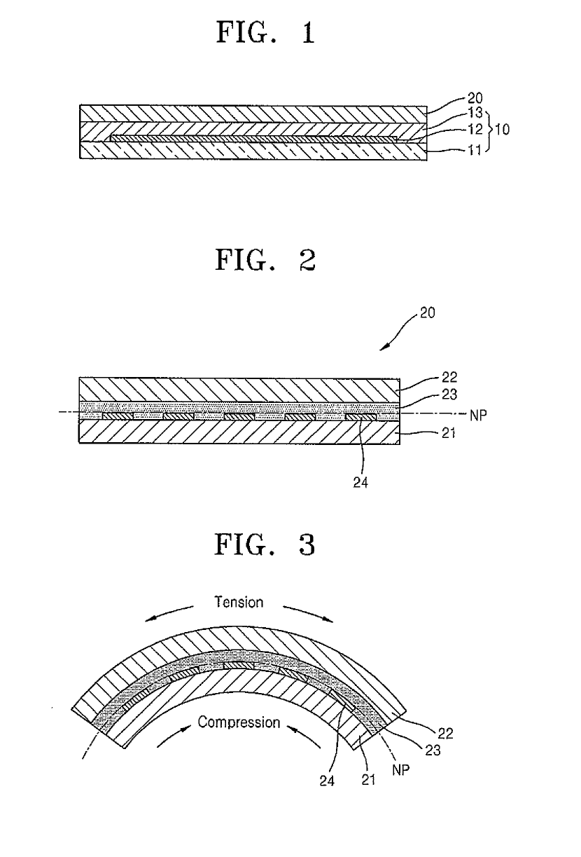

FIG. 1 is a cross-sectional diagram illustrating a flexible display apparatus according to an embodiment of the present invention. As illustrated, the flexible display apparatus of the present embodiment includes a flexible display panel 10 and a flexible touch screen panel 20. Hence, the flexible display apparatus of the present embodiment may be bent to have a curvature, as illustrated in FIG. 3.

The flexible display panel 10 includes a display unit 12 located on a flexible substrate 11 and configured to implement/display an image, and a thin-film encapsulation layer 13 to cover and protect the display unit 12. Because the flexible substrate 11 is used, as opposed to a hard glass substrate, the flexible display panel 10 may be freely bent within an allowed range.

Furthermore, the flexible touch screen panel 20, which is coupled to control the display unit 12 for displaying an image according to a touch of the flexible touch screen panel 20 (e.g., the flexible touch screen panel 20 is configured to recognize a touch from a user, and to send a signal corresponding to the touch to change the images displayed on the flexible display panel 10), is formed of a structure as illustrated in FIG. 2.

Referring to FIG. 2, a first film 21 and a second film 22, which may be made of polyethylene terephthalate (PET), are coupled by an adhesive 23, and a wiring layer 24, which may be made of conductive materials, such as ITO, is formed on the first film 21 (e.g., surrounded by/in the adhesive 23). That is, the wiring layer 24 is arranged between the first and second films 21 and 22, and the surface (e.g., the upper surface) of the wiring layer 24 is formed to be aligned with a neutral plane NP.

The neutral plane NP is a point, plane, line, curve, or region where compression stress and tensile stress are not applied when the flexible touch screen panel 20 is bent. For example, if the flexible touch screen panel 20 is bent, as illustrated in FIG. 3, compression stress is applied to the inside of the curvature (lower side in FIG. 3), and tensile stress is applied to the outside of the curvature (upper side in FIG. 3). Hence, the direction of the stress gradually moves from the compression direction to the tensile direction when moving from the inside of the curvature to the outside of the curvature, and there is a threshold point where both compression stress and tensile stress are not applied, which is the neutral plane NP (e.g., located within the adhesive 23). Furthermore, although the term “neutral plane” is used, the neutral plane NP need not be perfectly planar, and may include other shapes or forms without departing from the spirit and scope of the present invention.

Generally, the neutral plane NP exists at a point(s) having an intermediate thickness of the total thickness of the subject member (e.g., at a point(s) near the middle of the flexible touch screen panel 20), and if the wiring layer 24 is formed at this point(s), even when the flexible touch screen panel 20 is bent, stress is minimally applied/not applied to the wiring layer 24, thereby ensuring that the occurrence of cracks is reduced/restricted. Furthermore, the surface of the wiring layer 24 is located at, or near, the neutral plane NP to lower the possibility of the occurrence of cracks by preventing or reducing stress on the surface of the wiring layer 24.

In the present embodiment, the surface of the wiring layer 24 is aligned with the neutral plane NP because cracks would generally otherwise begin at the surface of the wiring layer 24. Even if the neutral plane NP does not exactly fit the surface of the wiring layer 24, if the wiring layer 24 is positioned around, or near, the neutral plane NP, the stress applied to the wiring layer 24 at the time of bending is reduced or minimized, and thus the occurrence of cracks may be sufficiently restricted. However, if the surface of the wiring layer 24 corresponds to the neutral plane NP, the possibility of the occurrence of defects may be further lowered by restricting the start of cracks by reducing the stress at the location(s) in the wiring layer 24 where cracks would otherwise begin to form.

The flexible display apparatus, including the flexible touch screen panel 20 and the flexible display panel 10, may be used as described below.

To form the touch screen panel 20 of the flexible display apparatus according to the present embodiment, the wiring layer 24 is formed on the first film 21, the adhesive 23 is interposed between the first film 21 and the second film 22, and the surface of the wiring layer 24 is levelled with, or aligned with, the neutral plane NP.

In this state, if the flexible display apparatus is bent, the flexible touch screen panel 20 is bent as shown in FIG. 3, and at this time, because the surface of the wiring layer 24 is positioned on, or at, the neutral plane NP (where compression stress or tensile stress is minimally applied, or is not applied at all), the possibility of the occurrence of cracks caused by the bending becomes very low.

Hence, if the flexible touch screen panel 20 having this structure is used, even when the flexible display apparatus is often bent, there is a substantially reduced chance that a disconnection defect/electrical discontinuity occurs due to cracks in the wiring layer 24. Therefore, a defect rate of products embodying the present embodiment may be significantly comparatively reduced.

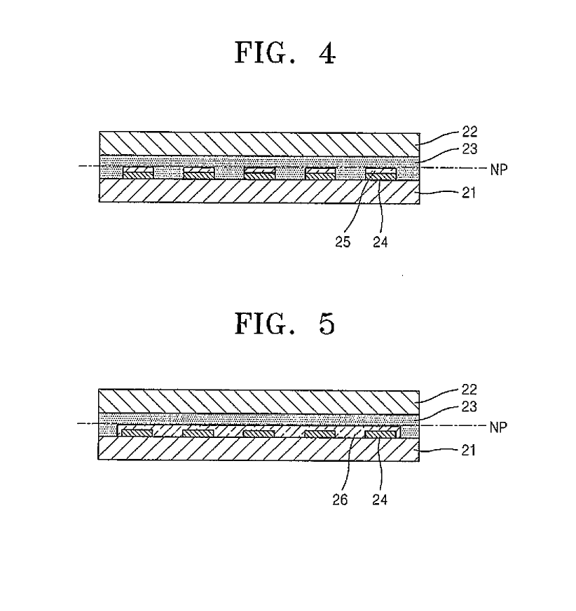

Furthermore, in the present embodiment, a separate protective film need not be formed on the wiring layer 24. However, as illustrated in FIGS. 4 and 5, flexibility supplementation films 25 and 26 may be formed to provide additional protection of the wiring layer 24 in other embodiments of the present invention. That is, the risk of damage to the wiring layer 24 due to bending may be further reduced by forming the flexibility supplementation films 25 and/or 26 that are made of relatively flexible materials. The flexibility supplementation films 25 and 26 may be formed of silver nanowires, metal mesh, graphene, dry film resist, etc.

The flexibility supplementation films 25 and 26 may be the flexibility supplementation film 25 coated on the wiring layer 24 and patterned with the wiring layer 24 (e.g., as shown in FIG. 4, the wiring layer 24 and the flexibility supplementation film 25 have the same pattern), and may also be the flexibility supplementation film 26 of the embodiment shown in FIG. 5, which is entirely coated on the wiring layer 24 after patterning the wiring layer 24.

Then, when the wiring layer 24 is bent, the wiring layer 24 is aligned with the neutral plane NP where stress is minimally applied/not applied, and the wiring layer 24 is further protected by the flexibility supplementation films 25 and 26, and thus, the occurrence of defects due to cracks in the wiring layer 24 may be reduced or prevented.

Hence, the flexible touch screen panel of the above-described structure effectively reduces/prevents/restricts the occurrence of cracks in the wiring layer, and thus, if the flexible touch screen panel of embodiments of the present invention is used in a flexible display apparatus, the occurrence of a defect, such as an electrical disconnection, may be significantly reduced.

While embodiments of the present invention have been particularly shown and described with reference to exemplary embodiments thereof, it will be understood by those of ordinary skill in the art that various changes in form and details may be made therein without departing from the spirit and scope of the present invention as defined by the following claims, and their equivalents.

What is claimed is:

1. A flexible touch screen panel comprising:
a flexible film; and
a wiring layer in the flexible film,
wherein the wiring layer is at a neutral plane within the flexible film, the neutral plane being a region where substantially no stress is applied when the flexible touch screen panel is bent.

2. The flexible touch screen panel of claim 1, wherein a surface of the wiring layer corresponds to the neutral plane.

3. The flexible touch screen panel of claim 1, wherein the flexible film comprises:
a first film on which the wiring layer is located; and
a second film above the wiring layer.

4. The flexible touch screen panel of claim 3, wherein the first film and the second film comprise polyethylene terephthalate (PET).

5. The flexible touch screen panel of claim 1, further comprising a flexibility supplementation film at an upper surface of the wiring layer.

6. The flexible touch screen panel of claim 5, wherein the flexibility supplementation film comprises at least one of silver nanowires, metal mesh, graphene, or dry film resist.

7. The flexible touch screen panel of claim 5, wherein the flexibility supplementation film and the wiring layer comprise a same pattern.

8. The flexible touch screen panel of claim 5, wherein the flexibility supplementation film completely covers the upper surface of the wiring layer.

9. A flexible display apparatus comprising:
a flexible display panel; and
a flexible touch screen panel coupled with the flexible display panel and configured to recognize a touch from a user and to send a signal corresponding to the touch,
wherein the flexible touch screen panel comprises:
a flexible film; and
a wiring layer that corresponds to a neutral plane of the flexible film, the neutral plane being a region where substantially no stress is applied when the flexible touch screen panel is bent.

10. The flexible display apparatus of claim 9, wherein a surface of the wiring layer corresponds to the neutral plane.

11. The flexible display apparatus of claim 9, wherein the flexible film comprises:
a first film on which the wiring layer is formed; and
a second film above the wiring layer.

12. The flexible display apparatus of claim 11, wherein the first film and the second film comprise polyethylene terephthalate (PET).

13. The flexible display apparatus of claim 9, further comprising a flexibility supplementation film at an upper surface of the wiring layer.

14. The flexibility display apparatus of claim 13, wherein the flexibility supplementation comprises at least one of silver nanowires, metal mesh, graphene, or dry film resist.

15. The flexibility display apparatus of claim 14, wherein the flexibility supplementation film is patterned the same as the wiring layer.

16. The flexibility display apparatus of claim 14, wherein the flexibility supplementation film completely covers the upper surface of the wiring layer.
